(19) United States
(12) Patent Application Publication
(10) Pub. No.: US 2025/0058481 A1
(43) Pub. Date: Feb. 20, 2025

(54) GRIPPING DEVICE AND GRIPPING METHOD

(71) Applicant: TOYOTA JIDOSHA KABUSHIKI KAISHA, Toyota-shi (JP)

(72) Inventors: Reoto Uetake, Nagoya-shi (JP); Akihiro Kimura, Toyota-shi (JP); Fuminori Saito, Nagoya-shi (JP); Hiroshi Bito, Toyota-shi (JP)

(73) Assignee: TOYOTA JIDOSHA KABUSHIKI KAISHA, Toyota-shi (JP)

(21) Appl. No.: 18/758,507

(22) Filed: Jun. 28, 2024

(30) Foreign Application Priority Data
Aug. 14, 2023 (JP) 2023-131879

(51) Int. Cl. B25J 15/06

(52) U.S. Cl. CPC B25J 15/0608

(57) ABSTRACT

A gripping device according to an embodiment includes a bag body that comes into contact with a workpiece that a magnetic body, the bag body having flexibility and airtightness and accommodating a granular material, an intake and exhaust unit that deforms the bag body to follow the shape of the workpiece, by discharging gas from the bag body or supplying gas to the bag body, when the bag body comes into contact with the workpiece, and a magnetic attraction unit that grips the workpiece by applying a magnetic force to the workpiece in a state where the bag body is deformed to follow the shape of the workpiece.

### CROSS-REFERENCE TO RELATED APPLICATION

This application claims priority to Japanese Patent Application No. 2023-131879 filed on Aug. 14, 2023 incorporated herein by reference in its entirety.

### BACKGROUND

### 1. Technical Field

The present disclosure relates to a gripping device and a gripping method.

### 2. Description of Related Art

As an end effector for an industrial robot, there is a gripper, a gripping device used to grip an object. Japanese Unexamined Patent Application Publication No. 2019-155534 (JP 2019-155534 A) discloses a magnetic gripper that holds a workpiece, which is a magnetic body, by a magnetic force. The magnetic gripper disclosed in JP 2019-155534 A is a permanent magnet type magnetic gripper, and can be switched between a holding state in which a workpiece is held by a magnetic force and a release state in which the holding is released.

In JP 2019-155534 A, a permanent magnet is disposed in a housing made of a non-magnetic material with an opening at the bottom so as to be movable in a vertical direction with a magnetized surface facing downward. An opening portion of the housing is formed in an inclined shape. This magnetic gripper enters the holding state when the entire magnetized surface of the permanent magnet protrudes from the opening portion of the housing, and enters the release state when at least a part of the magnetized surface sinks into the inside of the housing.

Further, Japanese Unexamined Patent Application Publication No. 2013-220492 (JP 2013-220492 A) discloses a gripping device that grips an object by pressing a bag body against the object which is placed on a support surface. In JP 2013-220492 A, a deformable bag body is pressed against an object, and a granular material is introduced inside the bag body to expand the bag body and reduce the space between the bag body and the object, and then among the granular material and gas inside the bag body, only the gas is sucked out and discharged to the outside of the bag body. This increases a frictional force between the particles of the granular material inside the bag body and helps the bag maintain its shape.

### SUMMARY

In JP 2019-155534 A, the magnetized surface of the permanent magnet facing downward becomes a gripping surface that grips the workpiece. When the shape of the workpiece and the shape of the gripping surface do not match well, the gripper may not be able to grip the workpiece. In particular, when rotation occurs between the gripping surface and the workpiece, gripping the workpiece with the gripper becomes more difficult.

When replacing the gripper depending on the shape and posture of the object to be gripped, it is necessary for an appropriate gripper to be selected and used as a replacement. In addition, complex calculations are required to plan the gripping of the object to be gripped by the selected gripper and to estimate the posture of the workpiece from the start of gripping to the completion of gripping. It is also assumed that an industrial robot equipped with such a gripper operates by performing, for example, machine learning. Such work related to replacing the gripper may lead to a decrease in the efficiency of the gripping work by a robot. Further, in JP 2013-220492 A, it is necessary to reduce the space between the bag body and the object to the extent that the object can be gripped, and thus a problem exists in which the object is limited.

The present disclosure provides a gripping device and a gripping method that can stably grip workpieces, which are magnetic bodies, of various shapes.

A first aspect of the present disclosure relates to a gripping device including a bag body, an intake and exhaust unit, and a magnetic attraction unit. The bag body comes into contact with a workpiece that is a magnetic body, the bag body having flexibility and airtightness and accommodating a granular material. The intake and exhaust unit deforms the bag body to follow the shape of the workpiece, by discharging gas from the bag body or supplying gas to the bag body, when the bag body comes into contact with the workpiece. The magnetic attraction unit grips the workpiece by applying a magnetic force to the workpiece in a state where the bag body is deformed to follow the shape of the workpiece.

A second aspect of the present disclosure relates to a gripping method including deforming a bag body having flexibility and airtightness and accommodating a granular material, the bag body coming into contact with a workpiece that is a magnetic body, to follow the shape of the workpiece, by discharging gas from the bag body or supplying gas to the bag body, when the bag body comes into contact with the workpiece, and gripping the workpiece by applying a magnetic force to the workpiece in a state where the bag body is deformed to follow the shape of the workpiece.

A third aspect of the present disclosure relates to a gripping device including a bag body, a vacuum pump, and a magnet. The bag body that is configured to comes into contact with a workpiece that is a magnetic body, the bag body having flexibility and airtightness and accommodating a granular material. The vacuum pump is configured to deform the bag body to follow the shape of the workpiece, by discharging gas from the bag body or supplying gas to the bag body, when the bag body comes into contact with the workpiece. The magnet is configured to grip the workpiece by applying a magnetic force to the workpiece in a state where the bag body is deformed to follow the shape of the workpiece.

With each aspect of the present disclosure, it is possible to stably grip workpieces, which are magnetic bodies, of various shapes.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic diagram illustrating a configuration of a gripping device according to a first embodiment;

FIG. 2 is a diagram for illustrating a gripping method according to the first embodiment; and

FIG. 3 is a schematic diagram illustrating a configuration of a gripping device according to a second embodiment.

### DETAILED DESCRIPTION OF EMBODIMENTS

Embodiments of the present disclosure will be described below with reference to the drawings. The numerical values, shapes, materials, components, arrangement positions of the components, steps and order of steps, and the like shown in the following embodiments are examples and do not limit the present disclosure.

Further, since the drawings are simplified, the technical scope of the present disclosure should not be narrowly interpreted based on the descriptions in the drawings. It should be noted that for illustrative purposes, the drawings are not drawn to scale. In each drawing, the same elements are designated by the same reference numerals, and redundant descriptions will be omitted.

### First Embodiment

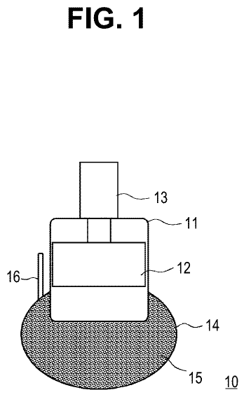

FIG. 1 is a schematic diagram illustrating a configuration of a gripping device 10 according to a first embodiment. As illustrated in FIG. 1, the gripping device 10 includes a housing 11, a magnet 12, an air cylinder 13, a bag body 14, a granular material 15, and an intake and exhaust unit 16. The gripping device 10 is a magnetic gripper that can switch between a gripping state in which a workpiece W, which is a magnetic body, is gripped by a magnetic force and a release state in which gripping is released.

In an example illustrated in FIG. 1, the housing 11 is a hollow rectangular parallelepiped. An opening portion is provided at a lower end of the housing 11. The housing 11 is made of a non-magnetic body. Examples of the material of the housing 11 include stainless steel, copper, and aluminum. Further, the housing 11 may be made of resin or ceramic.

The magnet 12 is arranged in the housing 11. The magnet 12 may include, for example, a permanent magnet such as a ferrite magnet or a neodymium magnet. The magnet 12 may be an electromagnet of which generation of a magnetic force can be electrically controlled.

The magnet 12 is vertically movable in the housing 11. In the example illustrated in FIG. 1, the air cylinder 13 is provided in an upper portion of the housing 11, and the air cylinder 13 moves the magnet 12 vertically in the housing 11. The magnet 12 and the air cylinder 13 correspond to a magnetic attraction unit described in the claims. Inside the housing 11, the air cylinder 13 functions as a switching unit that moves the magnet 12 closer to the workpiece W to bring it into the gripping state, and moves the magnet 12 away from the workpiece W to bring it into the released state. A mechanism which moves the magnet 12 may be another mechanism such as an electric actuator equipped with a motor.

As an example, the air cylinder 13 can be brought into the gripping state by causing the magnet 12 to protrude from the opening portion of the housing 11, and can be brought into the released state by sinking the magnet 12 into the housing 11. A lower end of the housing 11 may be an inclined opening portion as in JP 2019-155534 A. As a result, a state in which the magnet 12 partially protrudes from the housing 11 and is partially sunken is provided between a state in which the magnet 12 protrudes from the housing 11 and a state in which the magnet 12 sinks into the housing 11. According to this configuration, the grip of the workpiece W by the magnet 12 is released in stages.

At the lower end of the housing 11, the bag body 14 accommodating the granular material 15 is provided. The bag body 14 is a portion of the gripping device 10 that grips the workpiece W. The bag body 14 has flexibility and airtightness, and has a space inside. The bag body 14 is made of an elastically deformable material such as rubber or silicone rubber. The bag body 14 is not limited to being elastically deformable as long as it can be reversibly deformed in shape by an external force. Further, a material with high gas barrier properties may be used to prevent gas from escaping from the bag body 14.

The granular material 15 is accommodated in the space of the bag body 14. The granular material 15 filled in the bag body 14 behaves like a solid or a fluid due to the jamming transition, in such a manner that the bag body 14 transitions into a hardened state, which makes the bag body 14 resistant to deformation or the bag body 14 transitions into a softened state, which makes deformation possible.

The intake and exhaust unit 16 is connected to the bag body 14. For example, a vacuum pump or the like may be used as the intake and exhaust unit 16. The intake and exhaust unit 16 reduces the pressure inside the bag body 14 by discharging the gas inside the bag body 14, and pressurizes the inside of the bag body 14 by supplying gas into the bag body 14. The bag body 14 and the intake and exhaust unit 16 may be connected by a cylindrical pipe made of metal or resin.

The intake and exhaust unit 16 reduces the pressure inside the bag body 14 to a predetermined negative pressure by discharging gas (air) from the bag body 14, and brings the granular material 15 inside the bag body 14 into close contact with each other. In this way, gaps between the particles of the granular material 15 are reduced, making it not possible for the granular material 15 to move. As a result, the granular material 15 is solidified, and the bag body 14 transitions into a hardened state, making the bag body 14 resistant to deformation.

The intake and exhaust unit 16 also supplies gas to the bag body 14 to return the pressure inside the bag body 14 to, for example, atmospheric pressure, thereby creating gaps between the particles of the granular material 15 inside the bag body 14. By forming gaps between the particles of the granular material 15 in this manner, the granular material 15 can easily move in the bag body 14. As a result, the granular material 15 become fluid, and the bag body 14 becomes soft and easily deformed. That is, by controlling the intake and exhaust of the bag body 14 by the intake and exhaust unit 16, the bag body 14 can be switched to the hardened state or the softened state.

As the granular material 15, one that is easy to flow when changing the shape of the bag body 14 to follow the shape of the workpiece W is used. The shape of the granular material 15 is not particularly limited, and can be spherical, polygonal, jagged and uneven, and the like. The size of the granular material 15 can be such that when gas is discharged from the bag body 14, it is not discharged together with the gas. The size of the granular material 15 may be, for example, about 3 mm to 10 mm in diameter.

A filter may be provided between the bag body 14 and the intake and exhaust unit 16. The filter prevents the granular material 15 from entering the intake and exhaust unit 16. Such a filter has, for example, a mesh structure smaller than the diameter of the granular material 15.

The granular material 15 may be a non-magnetic powder. In this case, as the granular material 15, zirconia balls, resin beads, glass beads, or the like may be used. Further, as the granular material 15, coffee bean powder may be used. Moreover, the granular material 15 may be magnetic powders. In this case, an iron ball or the like is used as the granular material 15. When magnetic powder is used as the granular material 15, the granular material 15 can be magnetized by the magnetic field of the magnet 12. In this way, the magnet 12 can apply a magnetic force to the workpiece W via the granular material 15. The material of the granular material 15 is not limited to the example, and may be any material that can be filled into the bag body 14 and exhibit the jamming transition.

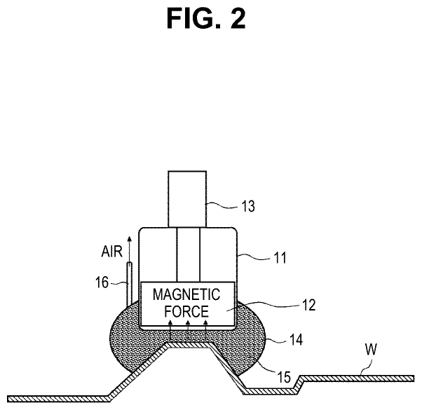

FIG. 2 is a diagram for illustrating a gripping method according to the first embodiment. As an example, first, the bag body 14 in the softened state is pressed against the workpiece W. Then, the intake and exhaust unit 16 exhausts the gas inside the bag body 14, thereby changing the shape of the bag body 14 to match the shape of the workpiece W. Then, with the bag body 14 deformed to follow the shape of the workpiece W, the magnet 12 is moved closer to the workpiece W, and a magnetic force is applied to the workpiece W to grip the workpiece W.

FIG. 2 illustrates a state in which the workpiece W, which is a magnetic body, is gripped by the magnetic force of the magnet 12. As illustrated in FIG. 2, the bag body 14 in the hardened state has a shape that follows the workpiece W. When the workpiece W is gripped by the magnet 12 with the shape of the workpiece W matching the shape of the bag body 14 in this way, the workpiece W can be stably held without rotating on a gripping surface.

Further, when the shape or posture of the workpiece W is different, the intake and exhaust unit 16 controls the intake and exhaust of the bag body 14, so that the bag body 14 can be transformed into a different shape. This makes it possible to suppress a decrease in work efficiency due to gripper replacement work.

### Second Embodiment

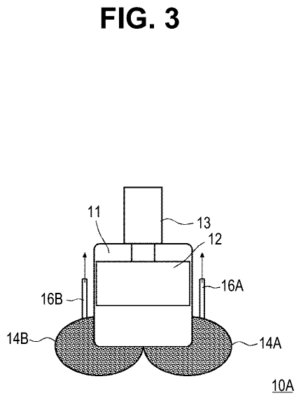

FIG. 3 is a schematic diagram illustrating a configuration of a gripping device 10A according to a second embodiment. The second embodiment differs from the first embodiment in that two bag bodies 14A, 14B each accommodating the granular material 15 are provided. In the example illustrated in FIG. 3, the bag body 14A and the bag body 14B are arranged side by side on an opening portion side of one housing 11. The number of bag bodies 14 is not limited to this example. Further, the bag body 14A and the bag body 14B may be arranged with a predetermined interval between them.

An intake and exhaust unit 16A is connected to the bag body 14A, and an intake and exhaust unit 16B is connected to the bag body 14B. The intake and exhaust unit 16A controls the intake and exhaust of the bag body 14A, and controls the shape of the bag body 14A, and the intake and exhaust unit 16B controls the intake and exhaust of the bag body 14B, and controls the shape of the bag body 14B. By providing a plurality of bag bodies 14A, 14B in this manner, a gripping surface formed by the bag bodies 14A, 14B can be shaped to follow the shape of the workpiece W to be gripped. This makes it possible to grip the workpiece W more stably.

Only one of the intake and exhaust unit 16A or the intake and exhaust unit 16B may be operated. That is, it is also possible to grip the workpiece W by the magnet 12 with one of the bag bodies 14A, 14B in a hardened state and the other in a softened state.

The present disclosure is not limited to the embodiments, and can be modified as appropriate without departing from the spirit. In the example, the magnetic attraction unit deforms the bag body 14 to follow the shape of the workpiece W, and then applies a magnetic force to the workpiece W, but the present disclosure is not limited thereto. For example, after the workpiece W is gripped by the magnet 12, the gas inside the bag body 14 may be exhausted by the intake and exhaust unit 16.

What is claimed is:

1. A gripping device, comprising:
a bag body that comes into contact with a workpiece that is a magnetic body, the bag body having flexibility and airtightness and accommodating a granular material;
an intake and exhaust unit that deforms the bag body to follow a shape of the workpiece, by discharging gas from the bag body or supplying gas to the bag body, when the bag body comes into contact with the workpiece; and
a magnetic attraction unit that grips the workpiece by applying a magnetic force to the workpiece in a state where the bag body is deformed to follow the shape of the workpiece.

2. The gripping device according to claim 1, wherein:
the granular material is a magnetic powder; and
the magnetic attraction unit applies a magnetic force to the workpiece via the granular material.

3. The gripping device according to claim 1, wherein the magnetic attraction unit applies a magnetic force to the workpiece after deforming the bag body to follow the shape of the workpiece.

4. The gripping device according to claim 1, wherein the magnetic attraction unit is configured to switch between a gripping state in which the workpiece is gripped by a magnetic force and a release state in which gripping is released.

5. The gripping device according to claim 4, wherein
the magnetic attraction unit includes,
a magnet installed inside a housing, and
a switching unit in the housing that moves the magnet closer to the workpiece to bring the magnetic attraction unit into the gripping state, and moves the magnet away from the workpiece to bring the magnetic attraction unit to the release state.

6. A gripping method, comprising:
deforming a bag body having flexibility and airtightness and accommodating a granular material, the bag body coming into contact with a workpiece that is a magnetic body, to follow a shape of the workpiece, by discharging gas from the bag body or supplying gas to the bag body, when the bag body comes into contact with the workpiece; and
gripping the workpiece by applying a magnetic force to the workpiece in a state where the bag body is deformed to follow the shape of the workpiece.

7. A gripping device, comprising:
a bag body that is configured to come into contact with a workpiece that is a magnetic body, the bag body having flexibility and airtightness and accommodating a granular material;
a vacuum pump that is configured to deform the bag body to follow a shape of the workpiece, by discharging gas from the bag body or supplying gas to the bag body, when the bag body comes into contact with the workpiece; and
a magnet that is configured to grip the workpiece by applying a magnetic force to the workpiece in a state where the bag body is deformed to follow the shape of the workpiece.

8. The gripping device according to claim 7, wherein:
the granular material is a magnetic powder; and
the magnet is configured to apply a magnetic force to the workpiece via the granular material.

9. The gripping device according to claim 7, wherein the magnet is configured to apply a magnetic force to the workpiece after deforming the bag body to follow the shape of the workpiece.

10. The gripping device according to claim 7, wherein the magnet is configured to switch between a gripping state in which the workpiece is gripped by a magnetic force and a release state in which gripping is released.

11. The gripping device according to claim 10, wherein
the magnet includes,
the magnet installed inside a housing, and
an electric actuator in the housing that is configured to move the magnet closer to the workpiece to bring the magnet into the gripping state, and is configured to move the magnet away from the workpiece to bring the magnet to the release state.
